(19) United States
(12) Patent Application Publication
(10) Pub. No.: US 2025/0341832 A1
(43) Pub. Date: Nov. 6, 2025

(54) TECHNIQUES FOR CONTROL OF MULTIPLE TYPES OF DRONES WITH A CENTRAL CONTROL SYSTEM

(71) Applicant: Nova Sky Stories LLC, Boulder, CO (US)

(72) Inventors: Daniel Gurdan, Germering (DE); Tobias Gurdan, Germering (DE); Donald Degnan, Boulder, CO (US); Michael Platz, Munich (DE); Andreas Jalsovec, Munich (DE); Philipp Bernhart, Munich (DE); Patrick Omland, Munich (DE)

(21) Appl. No.: 18/655,032

(22) Filed: May 3, 2024

(51) Int. Cl. G05D 1/225; G05D 1/692; G05D 1/695; G05D 105/65; G05D 109/25

(52) U.S. Cl. CPC G05D 1/225; G05D 1/692; G05D 1/695; G05D 2105/65; G05D 2109/254

(57) ABSTRACT

Methods and apparatus to create and perform drone displays are disclosed. An example drone display may include a first set of drones having a first drone type, and a second set of drones having a second drone type. A flight controller at each drone may provide commands to drone hardware through an abstraction layer, where the commands from the flight controller are common across different drone types and the abstraction layer translates the commands to drone-specific signals based on a configured drone type. A central management system may provide flight paths to the different sets of drones in a common format across different drone types, and may control multiple different types of drones using the common format.

### FIELD OF TECHNOLOGY

This disclosure relates generally to drones, and, more particularly, to techniques for control of multiple different types of drones with a central control system.

### BACKGROUND

Aerial displays have traditionally been provided fireworks or large-scale projections, but in recent years, fleets of lighted drones have been used to provide such displays. These drones, also referred to as Unmanned Aerial Vehicles (UAVs), employ advanced technology, including GPS and flight control algorithms, to execute synchronized movements in the night sky. Each deployed drone, fitted with programmable LEDs, may acts like a pixel in a three-dimensional canvas, creating a captivating visual ensemble that goes beyond the 2D limitations of traditional screen-based displays.

Such aerial displays may be used in community light shows, advertising campaigns, music festivals, sporting events, and the like, and provide a more sustainable, versatile, and safer alternative to fireworks or other pyrotechnics that have traditionally been used for aerial displays. These light-filled displays can reproduce logos, text, and intricate animations, transforming the night sky into large real-time digital display that can be widely viewed by a large number of people. As such aerial displays become more complex, efficient techniques for reliably controlling a fleet of drones may further enhance viewing experiences and reduce cost and complexity for drone shows.

### SUMMARY

Various aspects discussed herein provide system and control method for controlling one or more sets of drones (e.g., multicopter UAVs) during synchronized flight operations. For example, the system and control method may be used to provide a large aerial light show in which drones of a first set of drones may each provide a pixel in a three-dimensional (3D) display, and one or more drones of a second set of drones provide character drones that interact with the 3D display. Such aerial displays may be used, for example, for community light shows, theme parks, concert venues, sports stadiums, music festivals, and other settings to provide a choreographed display for a large number of observers.

In some aspects, techniques described herein may be used to control a relatively large number of drones (e.g., tens to hundreds) that include multiple different types of drones that have different flight characteristics. In some cases, a single operator may be able to manage a drone display using a central management system that sends common flight path information to the multiple different types of drones to execute multiple coordinated flight paths.

In accordance with some aspects, a drone control apparatus is provided. The drone apparatus may include a flight controller configured to execute drone flight movements based at least in part on a flight path received from a central management system; one or more sensors coupled with the flight controller that provide drone position information; and an abstraction layer coupled with the flight controller that provides a drone hardware interface and is adapted to be coupled with a drone to provide control signals to the drone, the control signals for one or more of a drone motor controller, a drone battery controller, a drone charging controller, or any combinations thereof, and where the abstraction layer converts signals from the flight controller into the control signals based at least in part on a drone type of the drone that is selected from multiple different available drone types.

In some aspects, the abstraction layer may include one or more hardware components, one or more software modules, or any combinations thereof. In some aspects, the drone control apparatus may further include a modular payload adapted to be coupled with the drone, the modular payload including one or more of a character body, a puppet, a mirror, a screen, a smoke generator, a dust generator, a laser, or any combinations thereof. In some aspects, the modular payload may include the dust generator and the laser, and where the flight controller is further configured to release a cloud of dust and activate the laser to provide an output directed toward the cloud of dust thereby making a beam from the laser visible to create a floating volumetric screen.

In some aspects, the abstraction layer is adapted to be coupled with at least two different types of drones of the multiple different available drone types and provides a common interface to the flight controller for the at least two different types of drones, and where the common interface is compatible with flight plans received at the flight controller from the central management system. In some aspects, a first type of drone of the two or more different types of drones is a character drone, and a second type of drone of the two or more different types of drones is a light drone. In some aspects, the flight plans include a series of drone positions and a timecode interface, and the flight controller provides a status interface to inform the central management system of a drone status.

In some aspects, flight controller may include a guidance and navigation module that directs movements of the drone; and a communication interface that provides a wireless communications link with the show operation manager. In some aspects, the one or more sensors comprise one or more of: a global navigation satellite system (GNSS) module (e.g., global positioning system (GPS) module); an inertial navigation system module; an air data sensor that measures one or more of airspeed, altitude, or angle of attack; an angle of attack sensor; a magnetometer; a radio altimeter sensor; a proximity sensor; or any combinations thereof.

In accordance with other aspects a system for a visual drone display is provided. The system may include a first set of drones including multiple drones having a first drone type of two or more different types of drones; a second set of drones including one or more drones having a second drone type; a flight system that provides a drone flight path to each drone of the first set of drones and the second set of drones; and a central management system configured to control flight operations for each of the first set of drones and the second set of drones based at least in part on the drone flight path of each drone of the first set of drones and the second set of drones. In some aspects, each drone of each of the first set of drones and the second set of drones may include a flight controller configured to execute drone flight movements based at least in part on a flight path received from a central management system; and an abstraction layer coupled with the flight controller and a drone hardware interface and that provides control signals via the drone hardware interface for one or more of a drone motor controller, a drone battery controller, a drone charging controller, or any combinations thereof, and where the abstraction layer converts signals from the flight controller into the control signals based at least in part on whether the associated drone is the first drone type or the second drone type. In some aspects, the abstraction layer includes one or more hardware components, one or more software modules, or any combinations thereof.

In some aspects, each drone of the second set of drones may further include a modular payload adapted to be coupled with the drone, the modular payload including one or more of a character body, a puppet, a mirror, a screen, a smoke generator, a dust generator, a laser, or any combinations thereof. In some aspects, the abstraction layer may provide a common interface to the flight controller for at least the first drone type and the second drone type, and where the common interface is compatible with flight plans received at the flight controller from the central management system. In some aspects, the first drone type is a light drone, and a second drone type is a character drone. In some aspects, the flight plans include a series of drone positions and a timecode interface, and the flight controller provides a status interface to inform the central management system of a drone status.

In accordance with further aspects, a method for controlling a drone of multiple different types of drones in an aerial drone display. The method may include configuring the drone as a first drone type of the multiple different types of drones; receiving a drone flight path from a central management system, the drone flight path including a series of drone positions and a timecode associated with each drone position of the series of drone positions; receiving drone position information from one or more sensors; determining, based at least in part on the drone flight path, the drone position information, and the first drone type, a control signal to be provided to a drone controller to provide a drone movement to a drone position of the series of drone positions.

In some aspects, the method may further include determining, based at least on the first drone type, one or more control commands to be provided to a modular payload that is coupled with the drone, the modular payload including one or more of a character body, a puppet, a mirror, a screen, a smoke generator, a dust generator, a laser, or any combinations thereof. In some aspects, the modular payload includes the dust generator and the laser, and where the one or more control commands includes a command to release a cloud of dust and activate the laser to provide an output directed toward the cloud of dust thereby making a beam from the laser visible to create a floating volumetric screen.

In some aspects, the method may further include transmitting, to the central management system, a drone status that includes the drone position and current timecode of the drone; and receiving, from the central management system, an update to the drone flight path that updates one or more subsequent drone positions associated with one or more subsequent timecodes. In some aspects, the one or more sensors comprise one or more of: a GNSS module; an inertial navigation system module; an air data sensor that measures one or more of airspeed, altitude, and angle of attack; an angle of attack sensor; a magnetometer; a radio altimeter sensor; a proximity sensor; or any combinations thereof.

### BRIEF DESCRIPTION OF THE DRAWINGS

FIG. 1 shows an example of a drone or UAV in accordance with various aspects of the disclosure.

FIG. 2 shows an example of a drone display system and drone display that includes two or more different types of drones in accordance with various aspects of the disclosure.

FIG. 3 shows a block diagram of an example drone in accordance with various aspects of the disclosure.

FIG. 4 shows an example of multiple sets of different types of drones with a payload deployment in accordance with various aspects of the disclosure.

FIG. 5 shows a block diagram of an example processor platform that supports drone interaction with a moving platform in accordance with various aspects of the disclosure.

FIG. 6 shows an example of a method that supports control of multiple types of drones with a central control system in accordance with various aspects of the disclosure.

FIG. 7 shows an example of another method that supports control of multiple types of drones with a central control system in accordance with various aspects of the disclosure.

### DETAILED DESCRIPTION

Presenting displays to audiences (e.g., at a concert, in a stadium, at an outdoor venue, in an indoor venue, at an outdoor aquatic event, at a race, at a theme park, etc.) can be challenging. For example, in established venues, physical screens may be installed, which are directed toward certain viewing areas, and may be visible to all or a subset of the audience. However, such displays are limited in size to the physical screens, and to the location(s) of the physical screens. Further, in many instances displays are desired to be provided in areas that simply do not have physical screens present or may not be amenable to a temporary or permanent installation of such screens. To overcome these challenges, a fleet of choreographed, flying, light-emitting unmanned aerial vehicles (UAVs), also referred to as drones, can be used to create drone displays (e.g., a static and/or moving virtual displays in the air). In some examples, a display may be partially or wholly formed by drones. Drone displays can be tilted, curved, spherical, two-dimensional (2D), three-dimensional (3D), geometric, non-geometric, animated, or any combinations thereof. In some examples, drone displays are easily viewed, easily customizable, and may be reusable for multiple events.

In some examples, drone displays have configurable resolutions, are dynamically locatable (e.g., movable between various positions), are arbitrarily shaped (e.g., geometric, non-geometric, etc.), are dynamically shaped (e.g., a shape that is morphing, changing, etc.), and/or are dynamically sizable. Compared to conventional physical screens, some drone displays can be dynamic entities that can move, change and/or be part of a presented show. In accordance with some aspects as discussed herein, two or more different types of drones that have different flight characteristics may be included in a drone display and controlled by a single management system. Traditionally, different types of drones are separately controlled by different management systems. For example, a first set of drones may include multiple drones having a first drone type (e.g., a swarm of light drones that each provide a light pixel in an aerial display), and a second set of drones (e.g., that may include one drone or multiple drones) may carry props like puppets or foam parts giving the drones a special appearance (e.g., which may be referred to as “costume drones,” or “character drones”), or may carry special effects like fireworks or other pyrotechnics. Such different types of specialized drones may be referred to herein generally as “character drones.”

Traditionally, character drones are custom made and based on drone autopilot systems such as open source solutions (e.g., PX4, ArduPilot, etc.), or commercial drones (e.g., drones manufactured by DJI Technology Co., Ltd. of Shenzhen, China), where each manufacturer and project have individual protocols and navigation command interfaces. Integrating different drones into the same environment is consequently often difficult and time consuming, due to the separate protocols and interfaces of different types of drones.

In some aspects, a modular drone control and navigation stack is provided for show drones, which may be used to control multiple different types of drones at the drone hardware level, and provides that different types of drones have a same interface and are compatible with the same interfaces for show design and show operations. In some cases, drone control systems may include a drone autopilot, a drone hardware abstraction layer, a guidance and navigation module, and a communication interface. The drone autopilot may provide, for example, sensing and flight control. The drone hardware abstraction layer may provide, for example, an interface with different types of drones and may include motor controllers or a motor controller interface, a battery or battery interface, charging electronics or charging interface, a payload controller interface, or any combinations thereof. The guidance and navigation module may provide, for example, interpretation and execution of standardized show files. The communication interface may provide, for example, communications hardware (e.g., antenna(s), power amplifier(s), filter(s), encoder(s), decoder(s), etc., that provide physical layer over-the-air communications) and software (e.g., protocol layers for data communications). A show control system may interface (e.g., via the communications interface) with the modular drone control and navigation stack associated with multiple drones, and may provide show operations functions as well as show design tools. For example, the show design tools may be used to develop a show design (e.g., an animated 3D design using light pixels). The show operations functions may determine individual drone flight paths with a timecode interface, may interface with other show systems and a status interface that provides system status, and may provide updates to flight paths based on status information from one or more drones. The show control system may also provide hardware interfaces to other show control systems or elements.

In some aspects, a first set of drones may be light drones that include a light emitting diode (LED) module that is capable of providing multi-colored light output, where different lights states may be programmed based on flight path position and timecode. Such drones of the first set of drones may be an example of a first drone type, and hardware interfaces to such first drone types may include an LED module interface, drone motor controller interface, drone battery controller interface, drone charging controller interface, drone payload controller interface, or any combinations thereof. In some aspects, a second set of drones may be character drones that may be an example of a second drone type. In some cases, character drones may be substantially larger, heavier, or both, than light drones, and may have substantially different hardware (e.g., more rotors than light drones, larger motors than light drones, larger batteries than light drones, etc.). In some cases, hardware interfaces to such second drone types may include an LED module interface, drone motor controller interface, drone battery controller interface, drone charging controller interface, drone payload controller interface, or any combinations thereof. In some aspects, character drones may include a modular payload such as mirrors that reflect ground light, sunlight, or light emitted from other drones (e.g., LED, laser light), screens that reflect light, laser, or projection mapping, puppets, foam forms in the shape of a vehicle or character body, smoke (e.g., for daytime “painting in the sky” to form letters or flying multiple drones that provide dots of smoke to draw in a 2D or 3D dot matrix), dust dispersant hardware (e.g., hardware that disperses flour in a cloud such that laser beams directed into the cloud are reflected and are thereby visible to create a floating volumetric screen.

Reference will now be made in detail to non-limiting examples, some of which are illustrated in the accompanying drawings.

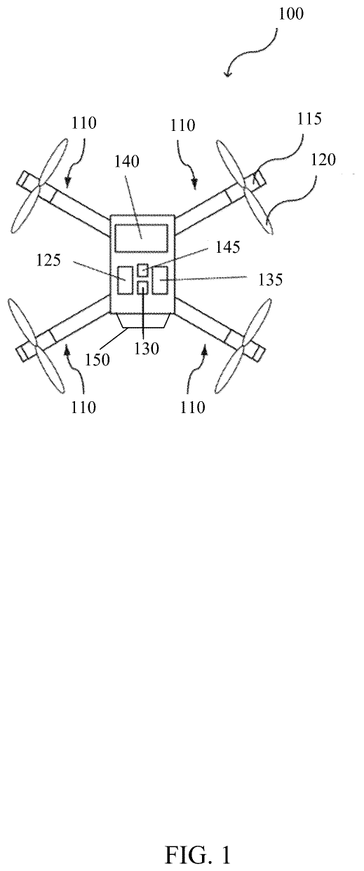

FIG. 1 shows an example of a drone 100 or UAV in accordance with various aspects of the disclosure. The drone 100 may include a plurality of (e.g., three or more than three, e.g., four, six, eight, etc.) vehicle drive arrangements 110. Each of the vehicle drive arrangements 110 may include at least one drive motor 115 and at least one propeller 120 coupled with the at least one drive motor 115. The one or more drive motors 115 of the drone 100 may be electric drive motors.

Further, the drone 100 may include one or more processors 125 configured to control flight or any other operation of the drone 100 including but not limited to navigation, image analysis, location calculation, and any method or action described herein. One or more of the processors 125 may be part of a flight controller or may implement a flight controller. The one or more processors 125 may be configured, for example, to provide a flight path based at least on an actual position of the drone 100 and a desired target position for the drone 100. In some aspects, the one or more processors 125 may control the drone 100. In some aspects, the one or more processors 125 may control the drive motors 115 of the drone 100 via an abstraction layer and one or more motor controllers. The one or more processors 125 may include or may implement any type of controller suitable for controlling the desired functions of the drone 100. The one or more processors 125 may be implemented by any kind of one or more logic circuits.

According to various aspects, the drone 100 may include one or more memories 130. The one or more memories may be implemented by any kind of one or more electronic storing entities, e.g., one or more volatile memories and/or one or more non-volatile memories. The one or more memories 130 may be used, e.g., in interaction with the one or more processors 125, to build and/or store image data, ideal locations, locational calculations, alignment instructions, command translation instructions based on a configured drone type, or any combinations thereof.

Further, the drone 100 may include one or more power supplies 135. The one or more power supplies 135 may include any suitable type of power supply, e.g., a direct current (DC) power supply. A DC power supply may include one or more batteries (e.g., one or more rechargeable batteries), etc.

According to various aspects, the drone 100 may include one or more sensors 140. The one or more sensors 140 may be configured to monitor a vicinity of the drone 100. For example, the one or more sensors 140 may be configured to detect obstacles in the vicinity of the drone 100. The one or more sensors 140 may include, for example, one or more cameras (e.g., a depth camera, a stereo camera, a thermal imaging camera, etc.), one or more ultrasonic sensors, one or more positioning modules (e.g., global navigation satellite system (GNSS), such as a Global Positioning System (GPS) module, terrestrial-based positioning module, etc.), an inertial navigation system module; an air data sensor (e.g., that measures one or more of airspeed, altitude, and) an angle of attack sensor, a magnetometer, a radio altimeter sensor, one or more proximity sensors, or any combinations thereof.

The drone 100 may further include an abstraction layer 145 that provides a common interface to flight control systems for two or more different types of drones. The abstraction layer 145, for example, may receive commands (e.g., from a flight controller) that are not specific to a particular type of drone, and may translate the received commands to drone-specific commands based on a configured type of the drone 100. The abstraction layer 145 may provide, for example, a modular interface with different types of drones and may include motor controllers or a motor controller interface, a battery or battery interface, charging electronics or charging interface, a payload controller interface, or any combinations thereof. The drone 100 may also include a light module 150 (e.g., an LED module that can be activated to different light states as part of an aerial display) or payload.

According to various aspects, at least one of the one or more processors 125 may an interface to a communications interface that includes at least one transceiver configured to provide an uplink transmission and/or downlink reception of radio signals including data (e.g., video or image data and/or commands, platform position information, etc.). The at least one transceiver may include a radio frequency (RF) transmitter and/or a radio frequency (RF) receiver.

In some aspects, the one or more sensors 140 may further include an inertial measurement unit (IMU) and/or a compass unit. The inertial measurement unit may allow, for example, a calibration of the drone 100 regarding a predefined plane in a coordinate system, e.g., to determine the roll and pitch angle of the drone 100 with respect to the gravity vector (e.g., from planet earth). Thus, an orientation of the drone 100 in a coordinate system may be determined. The orientation of the drone 100 may be calibrated using the inertial measurement unit before the drone 100 is operated in flight modus. However, any other suitable function for navigation of the drone 100, e.g., for determining a position, a flight velocity, a flight direction, etc., may be implemented in the one or more processors 125, one or more sensors 140, and/or in additional components coupled to the one or more processors 125.

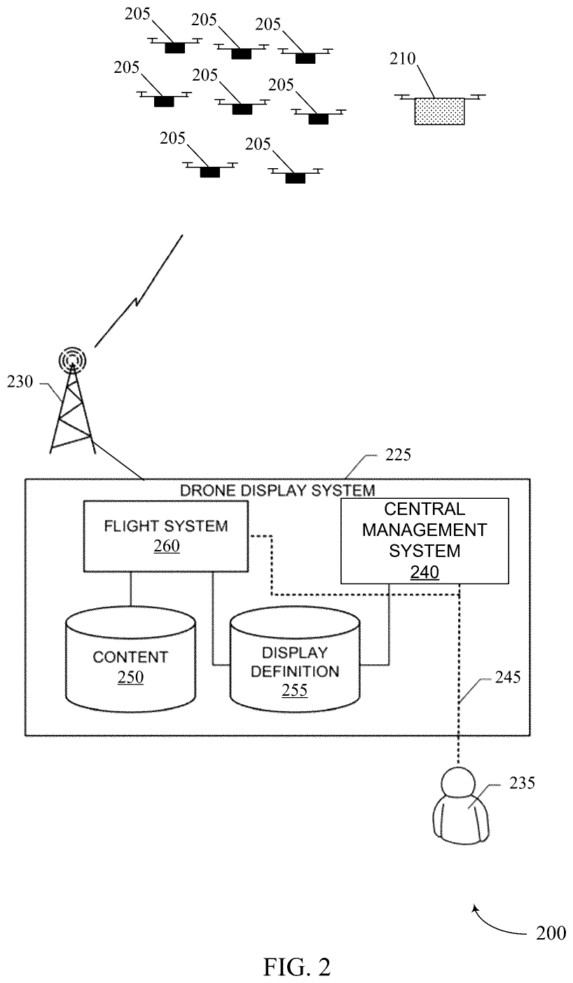

FIG. 2 shows an example of a drone display system 200 and drone display that includes two or more different types of drones in accordance with various aspects of the disclosure. The example drone display system 200 of FIG. 2 controls any number and/or type(s) of drones, including a first set of drones 205 having a first drone type (e.g., light drones) and a second set of one or more drones 210 having a second drone type (e.g., a character drone) to form an example drone display on which content is displayed (e.g., a 3D image formed of light pixels provided by the first set of drones 205 with which the character drone may interact). In some examples, drones 205 can display assorted colors in different directions.

In the illustrated example of FIG. 2, a drone display system 225 controls the first set of drones 205 and the second set of drones 210 to provide the drone display via a communications station 230 (e.g., a cellular radio head, a wireless access point (AP), a wireless hotspot, etc.). Additionally, or alternatively, the first set of drones 205 and the second set of drones 210 may be programmed by the drone display system 225, including any applicable safety precautions, and flown autonomously.

To enable a user 235 to control one or more aspects of the example drone display, the example drone display system 225 of FIG. 2 may include a central management system 240. In some examples, the central management system 240 may include a collection of standalone applications, a collection of integrated applications, etc., accessed via, for example, a user interface. In some examples, the central management system 240 may also provide for show design through one or more applications (e.g., web-based applications integrated to form a web-based drone design display portal or standalone applications integrated to present the appearance of an integrated solution). The user 235 via, for example, the user interface of the example central management system 240 of FIG. 2, may provide input(s) 245 that represent the configuration of the audience. Example inputs 245 include, but are not limited to, an arrangement of audience member viewing area(s), different elevations of different viewing areas, show design information, or any combinations thereof. Example inputs may, additionally, or alternatively, include design constraints or desired aspects of the drone display such as, shaped (e.g., curved as shown in FIG. 2), one-sided or more than one sides, viewing angle (e.g., an audience member doesn't have to look upward by more than N feet, or M feet left or right), etc. In some examples, some such inputs 245 are selected from a plurality of options or examples. Further, in accordance with various aspects, the user 235 may provide inputs for two or more different types of drones, and the central management system 240 may provide outputs for the two or more different types of drones using a same format (e.g., position information for a sequence or series of timecodes, light or payload operation for the sequence or series of timecodes, etc.).

In some examples, the central management system 240 of FIG. 2 may use the inputs 245 provided by the user 235 to design the drone display that incorporates the first set of drones 205 and the second set of drones 210 and that maps content 250 onto the drone display. In some examples, the central management system 240 stores the designed drone display in a display definition datastore 255 ahead of the drone display being activated. In some examples, the drone display for one or both of the first set of drones 205 and the second set of drones 210 may be designed in real time as the drone display is being used. The design of the drone display may be stored in the example display definition datastore 255 using any number and/or type(s) of data structures on any number and/or type(s) of computer-readable storage device or memory.

To activate (e.g., fly, begin displaying content, start, etc.) the example drone display, the example drone display system 225 includes an example flight system 260. In some cases, the example flight system 260 maps the content 250 (e.g., different lighting colors, lighting activation/deactivation, etc.) for each of the first set of drones 205 and the second set of drones 210 onto the drone display specified by the display definition 255, and activates the drone display. In some examples, the drone display may be designed prior to flying the drone display and stored for use in multiple shows, and in other examples the drone display for one or both of the first set of drones 205 and the second set of drones 210 may be designed in real time by the central management system 240 based on input from the user 235. In some examples, the user 235 can control the activation of one or both of the first set of drones 205 or the second set of drones 210 in the drone display via, for example, a user interface. The content 250 may be stored using any number and/or type(s) of data structures on any number and/or type(s) of computer-readable storage device or memory.

While an example manner of implementing the example drone display system 225 is illustrated in FIG. 2, one or more of the elements, processes or devices illustrated in FIG. 2 may be combined, divided, re-arranged, omitted, eliminated and/or implemented in any other way. Further, the example drone display design system 200 of FIG. 2 may include one or more elements, processes and/or devices in addition to, or instead of, those illustrated in FIG. 2, and/or may include more than one of any or all the illustrated elements, processes and devices.

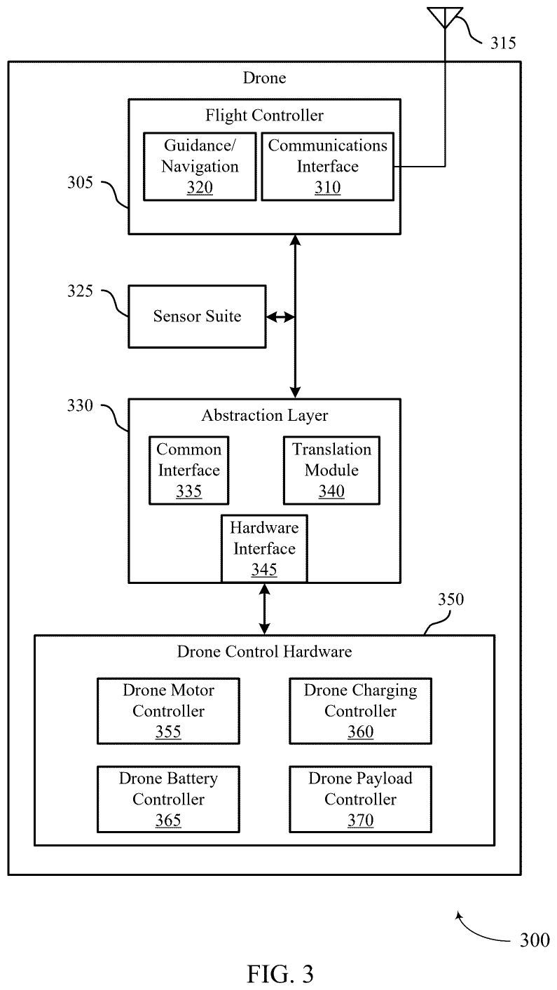

As discussed herein, in some aspects the drone display may incorporate operations of multiple different types of drones, where the drone display system 225 may provide output for the different types of drones on a common format. FIG. 3 discuses exemplary operations for a drone that can operate in an aerial display in accordance with a common control information format and a configured drone type.

While an example manner of implementing the drone display is illustrated in FIG. 2, one or more of the elements, processes and/or devices illustrated in FIG. 2 may be combined, divided, re-arranged, omitted, eliminated or implemented in any other way. Further, aspects of drone display system 225 may be implemented by hardware, software, firmware and/or any combination of hardware, software and/or firmware. Thus, for example, any of the example central management system 240 content 250 storage, display definition 255 storage, or flight system 260 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the components is/are hereby expressly defined to include a non-transitory computer-readable storage device or storage disk such as a memory, a digital versatile disk (DVD), a compact disc (CD), a Blu-ray disk, etc. including the software and/or firmware. Further still, the example drone display system 225 of FIG. 2 may include one or more elements, processes and/or devices in addition to, or instead of, those illustrated in FIG. 2, and/or may include more than one of any or all the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

FIG. 3 shows a block diagram of an example drone 300 in accordance with various aspects of the disclosure. The drone 300 may be an example of any of drones 100, 205, or 210, as discussed in FIGS. 1 and 2. In this example, the drone 300 may include a flight controller 305 that may include a guidance and navigation module 320 and a communication interface 310. The communication interface 310 may provide wireless communications with a central controller (e.g., drone display system 225 of FIG. 2) via antenna 315 (and/or a wired interface), and may communicate flight information and status information with the central controller.

The flight controller 305 may provide hardware and software that stabilizes and guides drone operations. In some aspects, the flight controller may include one or more processors or controllers that interpret incoming signals from various onboard sensors, receivers, and inputs, then generates corresponding outputs to the drone control hardware 350 via an abstraction layer 330 to control, for example motor speed and direction. In accordance with various aspects, the flight controller 305 may output drone control commands that are generic for multiple different types of drones, and the abstraction layer 330 may convert the generic commands into drone-specific commands based on the type of drone that is configured at the abstraction layer 330. The flight controller 305 may facilitate navigation, programmed automated flights, or real-time control by the operator. Further, the flight controller may manage battery usage and ensure overall safety of drone flight operations (e.g., through one or more failsafe protocols, automatic triggering a safe landing or return-to-home function if the battery level becomes critically low or if there's a loss of signal from the controller, etc.). In some cases, the flight controller 305 may also provide obstacle detection and avoidance, telemetry data output, or both.

The drone may also include a sensor suite 325, that may include one or more sensors or modules that provide information on one or more drone 100 parameters. For example, the sensor suite 325 may include one or more of a GNSS module, an inertial navigation system module, an air data sensor that measures one or more of airspeed, altitude, and angle of attack, an angle of attack sensor, a magnetometer, a radio altimeter sensor, a proximity sensor, an optical sensor, or any combinations thereof. The flight controller 305 may receive information from the sensor suite 325 and determine drone flight operations based at least in part in the information from the sensor suite 325 and received flight path information (e.g., target positions, light state, payload state, and corresponding time stamps).

The flight controller 305, based on the determined drone flight operations, may output commands to control the drone 300 to perform one or more operations. For example, the flight controller 305, based on desired position data from the guidance and navigation module 320, may output a command to change an altitude and/or position of the drone 300, which may be received at a common interface 335 of the abstraction layer 330. The command to change an altitude and/or position of the drone 300 may be provided in a common format that is agnostic to a drone type of the drone 300 (e.g., a signal to increase drone elevation by 10 meters and move the drone to an updated set of coordinates) to the abstraction layer 330. The abstraction layer 330 may receive the command at common interface 335, and a translation module 340 may translate the command based on a configured drone type into a set of signals that is provided to hardware interface 345 and to drone control hardware 350. The drone control hardware 350 may include, for example, a drone motor controller 355, a drone charging controller 360, a drone battery controller 365, and a drone payload controller 370.

The abstraction layer 330 may include one or more hardware or software modules that provide a uniform interface for interaction with different types of drone 300 hardware. For example, the abstraction layer 330 may be configured with a first drone type associated with a light drone that is a multicopter drone with four rotors and four associated motors, and a command to change drone 300 position and/or altitude may be translated at translation module 340 into signals for each motor that will result in drone 300 movement to the desired position and altitude. In another example, the abstraction layer 330 may be configured with a second drone type associated with a character drone that is a multicopter drone with six rotors and six associated motors (or four rotors that have different motor response characteristics than motors of the first drone type), and a command to change drone 300 position and/or altitude may be translated at translation module 340 into signals for each of the motors that will result in drone 300 movement to the desired position and altitude. Further, the flight controller 305 may output a command associated with a drone payload (e.g., LED light module), and the abstraction layer 330 may translate the command into a corresponding command for the drone payload controller 370 based on the configured drone type. Thus, the abstraction layer 330 and flight controller 305 may be modular components of a drone control and navigation stack that are agnostic to a type of drone 300 being controlled, where the abstraction layer 330 may be configured with a particular type of drone and, based on the configured type of drone, the translation module may convert received commands into appropriate signals for the configured drone type. The abstraction layer 330 may thus allow a common flight controller 305 to interface with various hardware devices of different drone types, irrespective of their unique characteristics or communication protocols.

In some aspects, the abstraction layer 330 may translate system control commands into a format that the configured drone hardware can receive and execute, such as by receiving one or more generic commands that the flight controller 305 can use, and translating these commands into specific, hardware-dependent instructions that allow for the control and operation of the respective drone type. Such a modular design may provide enhanced system scalability and adaptability, and with an abstraction layer 330 in place, new drone types may be integrated into drone displays simply by developing a corresponding translation for the translation module 340 that can translate the generic commands into hardware-specific instructions, and allow a single central drone display system to control drone displays that include two or more different types of drones.

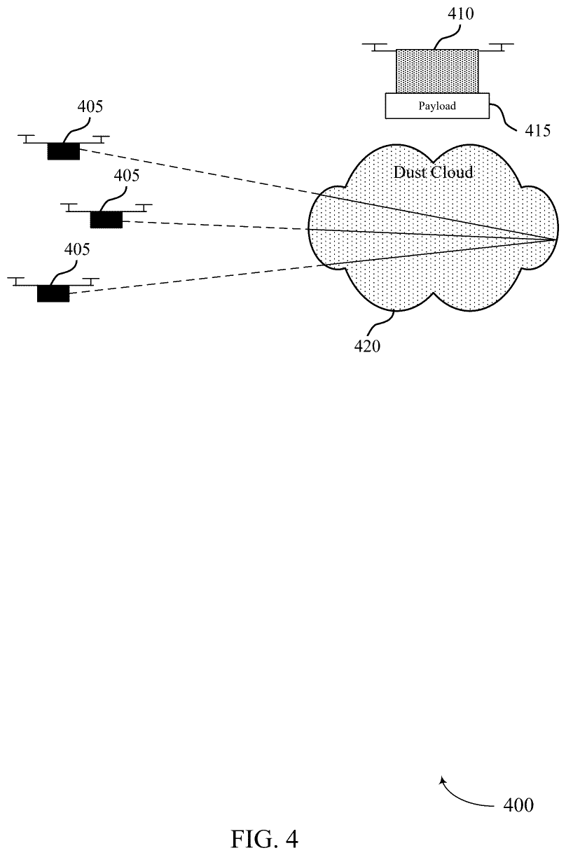

As discussed, in some aspects a second type of drone may include a payload that may operate to disperse a cloud of dust and a first type of drone may activate a laser beam directed toward the cloud of dust to make the beam visible in a volumetric display. FIG. 4 shows an example 400 of multiple sets of different types of drones with a payload deployment in accordance with various aspects of the disclosure. In this example, a drone display may include multiple drones 405 having a first drone type (e.g., light drones configured with lasers), and a character drone 410 having a second drone type.

The character drone 410 in this example includes a payload 415 that may operate to disperse a dust cloud 420 (e.g., the payload 415 may include flour that is scattered using a fan while the character drone 410 is moving in a desired area to create dust cloud 420. The multiple drones 405 may illuminate their associated lasers, with the resultant laser beams reflecting off of the dust particles in the dust cloud 420 to make the beams visible. In accordance with various aspects discussed herein, a central control system may control the multiple drones 405 and the character drone 410 using a common display design that is received at each drone and translated at a corresponding abstraction layer based on the type of drone.

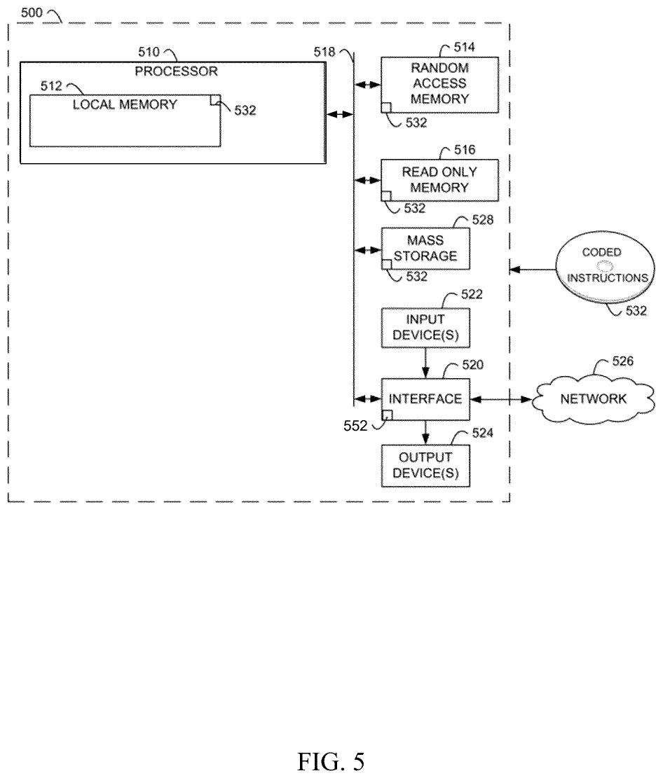

FIG. 5 shows a block diagram of an example processor platform 500 that supports common control of multiple different types of drones in accordance with various aspects of the disclosure. The processor platform 500 can be, for example, a server, a personal computer, a workstation, a mobile device (e.g., a cell phone, a smart phone, a tablet such as an IPAD™), or any other type of computing device.

The processor platform 500 of the illustrated example includes a processor 510. The processor 510 of the illustrated example is hardware. For example, the processor 510 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example drone display system 225, the example central management system 240, flight system 260, content 250 storage, display definition 255 storage, or any combinations thereof.

The processor 510 of the illustrated example includes a local memory 512 (e.g., a cache). The processor 510 of the illustrated example is in communication with a main memory including a volatile memory 514 and a non-volatile memory 516 via a bus 518. The volatile memory 514 may be implemented by Synchronous Dynamic Random-Access Memory (SDRAM), Dynamic Random-Access Memory (DRAM), and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface. In the illustrated example, the interface circuit 520 implements the example flight system.

In the illustrated example, one or more input devices 522 are connected to the interface circuit 520. The input device(s) 522 permit(s) a user to enter data and/or commands into the processor 510. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, solid state drives, CD drives, Blu-ray disk drives, redundant array of independent disks (RAID) systems, and DVD drives.

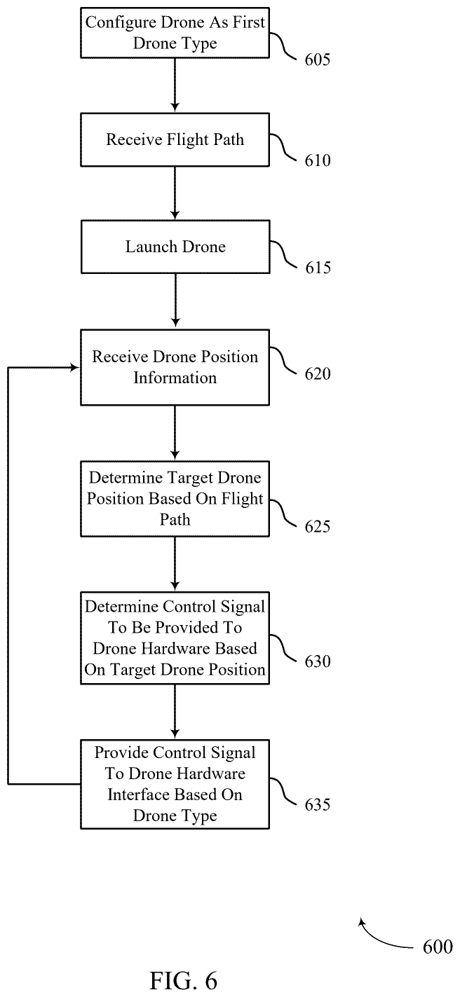

Coded instructions 532 including the coded instructions of FIGS. 5 and 6 may be stored in the mass storage device 528, in the volatile memory 514, in the non-volatile memory 516, and/or on a removable non-transitory computer-readable storage medium such as a CD-ROM or a DVD.

FIG. 6 shows an example of a method 600 that supports control of multiple types of drones with a central control system in accordance with various aspects of the disclosure. Aspects of FIG. 6 may be implemented by a drone in a drone display system, such as illustrated in FIGS. 2 and 4 that deploys two or more types of drones such as illustrated in FIGS. 1 and 3. The operations of method 600 may be implemented in hardware logic or machine-readable instructions for implementing the drone display. The machine-readable instructions may be a program or portion of a program for execution by a processor such as the processor of a flight controller shown in the example drone 300 discussed in connection with FIG. 3. The program may be embodied in software stored on a non-transitory computer-readable storage medium such as a memory associated with the processor, but the entire program and/or parts thereof could alternatively be executed by a device other than the processor and/or embodied in firmware or dedicated hardware. Further, although exemplary operations are described with reference to FIG. 6, many other methods of implementing the example drone display may alternatively be used. For example, the order of execution of the blocks may be changed, or some of the blocks described may be changed, eliminated, or combined. Additionally, or alternatively, any or all the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

In the example of FIG. 6, at 605, a drone may be configured as a first drone type. In some cases, such configuration may be provided when a flight controller and abstraction layer are coupled with a drone (e.g., by programming the abstraction layer with the first drone type of multiple different drone types).

At 610, the drone may receive a flight path. The flight path may be received, for example, from a drone display system as part of a configuration for an aerial drone display. In some cases, the flight path may include position information for the drone along with timecode information, such that a sequence of drone positions at different times relative to a start of the aerial drone display are provided.

At 615, the drone may be launched. The drone may be launched from a launch pad, for example, that houses the one or more drones. In some examples, the launch pad may be located on a platform.

At 620, the drone may continuously monitor its location and may receive drone position information. For example, the drone position information may be received from a GNSS module. In other examples, additionally or alternatively, location monitoring may be performed using a terrestrial-based positioning system, such as one or more beacons that may be used to triangulate position relative to a fixed point that is defined by the system. Location monitoring may include monitoring of drone location in latitude, longitude, and altitude, or based on a geographic coordinate system (e.g., WGS84). In some examples, an orientation of the drone may also be monitored. In some examples, the drones may triangulate a current position based at least in part on one or more visual/optical beacons, radio beacons, or ultra sonic beacons, which may be all active or passive (e.g., that reflect an incoming signal or beam), or a combination thereof.

At 625, the drone may determine a target drone position based on the flight path. In some cases, the target drone position may be based on a timecode associated with the flight path, that indicates the drone is to change positions.

At 630, the drone may determine a control signal to be provided to drone hardware based on the target drone position. For example, an abstraction layer at the drone, based on the configured drone type and the target drone position, may determine control signals for a set of motor controllers to move the drone to the target drone position. At 635, the drone may provide the determined control signals to a drone hardware interface based on the type of drone, and the operations at 620 through 635 may be repeated while the drone is operating according to the flight path.

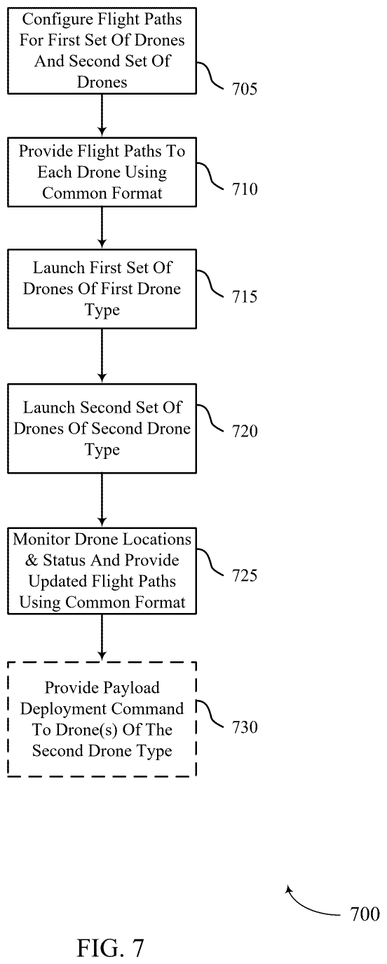

FIG. 7 shows an example of another method that supports control of multiple types of drones with a central control system in accordance with various aspects of the disclosure. Aspects of FIG. 7 may be implemented by a drone display system, such as illustrated in FIGS. 2 and 4 that deploys two or more types of drones such as illustrated in FIGS. 1 and 3. The operations of flow chart diagram 700 may be implemented in hardware logic or machine-readable instructions for implementing the drone display. The machine-readable instructions may be a program or portion of a program for execution by a processor such as the processor of a drone display system shown in the example of FIG. 2. The program may be embodied in software stored on a non-transitory computer-readable storage medium such as a memory associated with the processor, but the entire program and/or parts thereof could alternatively be executed by a device other than the processor and/or embodied in firmware or dedicated hardware. Further, although exemplary operations are described with reference to FIG. 7, many other methods of implementing the example drone display may alternatively be used. For example, the order of execution of the blocks may be changed, or some of the blocks described may be changed, eliminated, or combined. Additionally, or alternatively, any or all the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

In the example of FIG. 7, at 705, a drone display system may configure a set of flight paths for a first set of drones and a second set of drones. In some cases, the set of flight paths may include separate flight paths for each drone of each of the first set of drones and the second set of drones. In some cases, the first set of drones may include a plurality of light drones that have an LED module that is activated to different light states at different points in the flight path, and the second set of drones may include one or more character drones that may interact with the first set of drones in the aerial display.

At 710, the drone display system may provide the flight paths to each drone using a common format. For example, each flight path may be provided as a sequence of positions, drone states (e.g., a state of a light or payload of the drone), and timecodes, where the flight path has a format that is common for each type of drone.

At 715, the drone display system may launch the first set of drones of the first drone type. At 720, the drone display system may launch the second set of drones of the second drone type.

At 725, the drone display system may monitor drone locations and status, and provide updated flight plans using the common format. For example, the drones of the first and second sets of drones may provide periodic updates of a real-time location and status, and in the event that one or more flight plans are to be updated the drone display system may provide such updates. For example, if a drone reports a low battery level the drone flight path may be modified to land the drone and a flight path of a substitute drone may be modified to provide a replacement for the drone that was removed. In some examples, the updates of the drone position and status may be transmitted using a cellular connection, a Wi-Fi connection, or other radio frequency link between the drone display system and the one or more drones. In other examples, additionally or alternatively, communications between the drone display system and the one or more drones may be via optical communications, or via wired communications to a tethered drone. In further examples, one or more drones may relay received updates to one or more other drones (e.g., to provide redundancy in communications).

Optionally, at 730, the drone display system may provide a payload deployment comment to one or more drones of the second drone type. For example, the second drone type may include one or more character drones, and the drone display system may provide a command to actuate movement of a character that is the payload of the drone, or may provide a command to disperse a cloud or dust or smoke from the drone.

As mentioned above, the example processes of FIGS. 6 and 7 may be implemented using executable instructions (e.g., computer and/or machine-readable instructions) stored on a non-transitory computer and/or machine-readable medium such as a hard disk drive, a flash memory, a read-only memory, a CD-ROM, a DVD, a cache, a random-access memory and/or any other storage device or storage disk in which information is stored for any duration (e.g., for extended time periods, permanently, for brief instances, for temporarily buffering, and/or for caching of the information). As used herein, the term non-transitory computer-readable medium is expressly defined to include any type of computer-readable storage device and/or storage disk and to exclude propagating signals and to exclude transmission media.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B with C.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A drone control apparatus, comprising:
a flight controller configured to execute drone flight movements based at least in part on a flight path received from a central management system;
one or more sensors coupled with the flight controller that provide drone position information; and
an abstraction layer coupled with the flight controller that provides a drone hardware interface and is adapted to be coupled with a drone to provide control signals to the drone, the control signals for one or more of a drone motor controller, a drone battery controller, a drone charging controller, or any combinations thereof, and wherein the abstraction layer converts signals from the flight controller into the control signals based at least in part on a drone type of the drone that is selected from a plurality of different available drone types.

2. The drone control apparatus of claim 1, wherein the abstraction layer includes one or more hardware components, one or more software modules, or any combinations thereof.

3. The drone control apparatus of claim 1, further comprising:
a modular payload adapted to be coupled with the drone, the modular payload including one or more of a character body, a puppet, a mirror, a screen, a smoke generator, a dust generator, a laser, an LED light, pyrotechnics, or any combinations thereof.

4. The drone control apparatus of claim 3, wherein the modular payload includes the dust generator and the laser, and wherein the flight controller is further configured to release a cloud of dust and activate the laser to provide an output directed toward the cloud of dust thereby making a beam from the laser visible to create a floating volumetric screen.

5. The drone control apparatus of claim 1, wherein the abstraction layer is adapted to be coupled with at least two different types of drones of the plurality of different available drone types and provides a common interface to the flight controller for the at least two different types of drones, and wherein the common interface is compatible with flight plans received at the flight controller from the central management system.

6. The drone control apparatus of claim 5, wherein a first type of drone of the two or more different types of drones is a character drone, and a second type of drone of the two or more different types of drones is a light drone.

7. The drone control apparatus of claim 5, wherein the flight plans include a series of drone positions and a timecode interface, and the flight controller provides a status interface to inform the central management system of a drone status.

8. The drone control apparatus of claim 1, wherein the flight controller comprises:
a guidance and navigation module that directs movements of the drone; and
a communication interface that provides a wireless communications link with the central management system.

9. The drone control apparatus of claim 1, wherein the one or more sensors comprise one or more of:
a global navigation satellite system (GNSS) module;
a ground based radio navigation system receiver module;
a visual navigation module;
an inertial navigation system module;
an air data sensor that measures one or more of airspeed, altitude, and angle of attack;
an angle of attack sensor;
a magnetometer;
a radio altimeter sensor;
a proximity sensor;
or any combinations thereof.

10. A system for a visual drone display, comprising:
a first set of drones including a plurality of drones having a first drone type of two or more different types of drones;
a second set of drones including one or more drones having a second drone type;
a flight system that provides a drone flight path to each drone of the first set of drones and the second set of drones; and
a central management system configured to control flight operations for each of the first set of drones and the second set of drones based at least on the drone flight path of each drone of the first set of drones and the second set of drones; wherein
each drone of each of the first set of drones and the second set of drones comprises:
a flight controller configured to execute drone flight movements based at least in part on a flight path received from a central management system; and
an abstraction layer coupled with the flight controller and a drone hardware interface and that provides control signals via the drone hardware interface for one or more of a drone motor controller, a drone battery controller, a drone charging controller, or any combinations thereof, and wherein the abstraction layer converts signals from the flight controller into the control signals based at least in part on whether the associated drone is the first drone type or the second drone type.

11. The system of claim 10, wherein the abstraction layer includes one or more hardware components, one or more software modules, or any combinations thereof.

12. The system of claim 10, wherein each drone of the second set of drones further comprises:
a modular payload adapted to be coupled with the drone, the modular payload including one or more of a character body, a puppet, a mirror, a screen, a smoke generator, a dust generator, a laser, an LED light, pyrotechnics, or any combinations thereof.

13. The system of claim 10, wherein the abstraction layer provides a common interface to the flight controller for at least the first drone type and the second drone type, and wherein the common interface is compatible with flight plans received at the flight controller from the central management system.

14. The system of claim 13, wherein the first drone type is a light drone, and a second drone type is a character drone.

15. The system of claim 13, wherein the flight plans include a series of drone positions and a timecode interface, and the flight controller provides a status interface to inform the central management system of a drone status.

16. A method for controlling a drone of a plurality of different types of drones in an aerial drone display, comprising:
configuring the drone as a first drone type of the plurality of different types of drones;
receiving a drone flight path from a central management system, the drone flight path including a series of drone positions and a timecode associated with each drone position of the series of drone positions;
receiving drone position information from one or more sensors;
determining, based at least in part on the drone flight path, the drone position information, and the first drone type, a control signal to be provided to a drone controller to provide a drone movement to a drone position of the series of drone positions.

17. The method of claim 16, further comprising:
determining, based at least on the first drone type, one or more control commands to be provided to a modular payload that is coupled with the drone, the modular payload including one or more of a character body, a puppet, a mirror, a screen, a smoke generator, a dust generator, a laser, or any combinations thereof.

18. The method of claim 17, wherein the modular payload includes the dust generator and the laser, and wherein the one or more control commands includes a command to release a cloud of dust and activate the laser to provide an output directed toward the cloud of dust thereby making a beam from the laser visible to create a floating volumetric screen.

19. The method of claim 16, further comprising:
transmitting, to the central management system, a drone status that includes the drone position and current timecode of the drone; and
receiving, from the central management system, an update to the drone flight path that updates one or more subsequent drone positions associated with one or more subsequent timecodes.

20. The method of claim 16, wherein the one or more sensors comprise one or more of:
a global navigation satellite system (GNSS) module;
a ground based radio navigation system receiver module;
a visual navigation module;
an inertial navigation system module;
an air data sensor that measures one or more of airspeed, altitude, and angle of attack;
an angle of attack sensor;
a magnetometer;
a radio altimeter sensor;
a proximity sensor;
or any combinations thereof.
